(19) United States
(12) Patent Application Publication
(10) Pub. No.: US 2024/0426454 A1
(43) Pub. Date: Dec. 26, 2024

(54) LIGHTING DEVICE FOR A VEHICLE

(71) Applicant: HELLA GmbH & Co. KGaA, Lippstadt (DE)

(72) Inventors: Lukas LANGER, Bochum (DE); Dirk WILMES, Geseke (DE)

(73) Assignee: HELLA GmbH & Co. KGaA, Lippstadt (DE)

(21) Appl. No.: 18/755,577

(22) Filed: Jun. 26, 2024

(30) Foreign Application Priority Data
Jun. 26, 2023 (DE) 10 2023 116 688.3

(51) Int. Cl. F21S 43/20; F21S 43/14; F21S 43/239; F21S 43/249; F21S 43/31; G02F 1/1347

(52) U.S. Cl. CPC F21S 43/28133; F21S 43/14; F21S 43/239; F21S 43/249; F21S 43/2815; F21S 43/31; G02F 1/13475

(57) ABSTRACT

A lighting device for a vehicle, comprising at least one light source, a flat light guide with an input surface and at least one output surface. The light generated by the at least one light source enters the light guide at least partially through the input surface and exits at least partially from the at least one output surface. An LC display which has two opposing, at least partially transparent plates and a liquid crystal layer is arranged between these plates. One of the at least partially transparent plates of the LC display is formed by the flat light guide. The lighting device is configured such that the light emerging from the at least one output surface of the light guide passes at least partially through the liquid crystal layer of the LC display and subsequently through the LC display plate not formed by the light guide.

This nonprovisional application claims priority under 35 U.S.C. § 119 (a) to German Patent Application No. 10 2023 116 688.3, which was filed in Germany on Jun. 26, 2023, and which is herein incorporated by reference.

### BACKGROUND OF THE INVENTION

### Field of the Invention

The present invention relates to a lighting device for a vehicle.

### Description of the Background Art

A lighting device is known from WO 2023/025626 A1, which is incorporated herein by reference. The lighting device described therein comprises a lighting module, which has at least one light source and a luminous surface which is illuminated by the light source and from which light is emitted during operation of the lighting device, and an LC display which is arranged at least partly in front of the luminous surface such that, during operation of the lighting device, at least a portion of the light emerging from the luminous surface enters an input surface of the LC display and emerges from an output surface of the LC display, wherein the lighting device is configured such that the LC display is controlled in order to selectively allow portions of the light incident on the input surface to pass through the LC display and not to allow other portions of the light incident on the input surface to pass through the LC display. In this case, the light module is a separate light module to which the LC display is attached.

A disadvantage with lighting devices in the prior art is that the overall system is formed of multiple components which have to be attached individually and positioned in relation to each other. On the one hand, this leads to complex assembly and, on the other, to a loss of installation space.

### SUMMARY OF THE INVENTION

It is therefore an object of the present invention to provide a lighting device that can be produced more simply and/or more cost-effectively and can be designed more compact.

In an example, it is provided that one of the at least partially transparent plates of the LC display is formed by the flat light guide, wherein the lighting device is configured such that the light emerging from the at least one output surface of the light guide passes at least partially through the liquid crystal layer of the LC display and subsequently through the LC display plate not formed by the light guide. In this way, the light guide and the LC display are formed together in one piece so that they do not have to be mounted and positioned separately. Furthermore, the design of the lighting device is made more compact by combining the light guide and LC display.

It is possible that the lighting device is configured such that the LC display is controlled in order to selectively allow parts of the light emerging from the at least one output surface of the light guide to pass through the LC display and not to allow other parts of the light emerging from the at least one output surface of the light guide to pass through the LC display. By controlling the LC display, individual segments of the illuminated area formed by the output surface of the light guide can therefore be selectively switched. As a result, the lighting device can be configured to fulfill a signal function, in particular the function of a tail light or a tail-brake light or a tail-flashing light or a position-daytime running light or a position-flashing light.

It may be provided that the input surface of the light guide can be formed as an end face, in particular wherein the length and width of the light guide in a first direction and a second direction perpendicular thereto is significantly greater than the thickness of the light guide in a third direction perpendicular to the first and second directions, wherein the at least one output surface is arranged in a plane spanned by the first and second directions and the input surface is arranged in a plane spanned by the second and third directions. In particular, the thickness of the light guide can be a few millimeters, for example, between 2 mm and 3 mm, which results in a very compact design of the lighting device.

It is possible that the optical fiber can have a structuring, wherein the lighting device is configured such that light moving through the light guide is at least partially deflected by the structuring so that it emerges from the light guide through the output surface. The structuring can be arranged on a surface opposite the output surface adjacent to the liquid crystal layer. In particular, the scattering structure can scatter the light moving through the light guide during operation of the lighting device in such a way that the luminous surface formed by the output surface is homogeneously illuminated.

It can be provided that the lighting device can have a reflective layer which is arranged on the surface opposite the output surface. It can be ensured by the reflective layer that large parts of the light moving through the light guide reach the output surface and emerge from it.

Alternatively, it can be provided that the lighting device can have a reflector disposed outside the light guide, wherein the lighting device is configured such that light emerges from the surface opposite the output surface, is reflected again by the reflector in the direction of the light guide, again enters the light guide through the surface opposite the output surface, and emerges from the light guide through the output surface, so that it passes through the liquid crystal layer of the LC display and subsequently through the LC display plate not formed by the light guide.

It is possible that the at least one light source can be formed as a light-emitting diode, wherein in particular multiple light-emitting diodes are provided. In this regard, at least two of the light-emitting diodes can generate light with different colors during operation of the lighting device. This makes it possible to create an attractive design for the signal function of the lighting device using simple means. The light modules can be made equipped with variable LEDs in all colors, such as red, yellow, white, blue, cyan, or the like. When a blue color is used, the light modules are also suitable for the implementation and design of beacons for police vehicles. Two-color versions equipped with corresponding LEDs are also possible, such as, for example, red-yellow, yellow-white, or white-cyan.

It can be provided that the LC display can be a passive LC display. For an automotive lighting function, small areas are usually used, from which a high light output or a high brightness must be realized. For this reason, a high transmittance of the LC display is important to generate the legally required luminous intensities of a signal function. In contrast to an active LC display, a passive LC display does not have any active components such as transistors, for example, so that the transmittance of the passive LC display is significantly greater than that of an active LC display. Furthermore, a passive LC display can be manufactured much more cost-effectively than an active LC display.

It is possible that the LC display can be a guest-host display or a SmartGlass display. No polarizing filters are needed with such an LC display, so that a higher transmittance is available, which is advantageous and crucial for fulfilling a lighting function in the case of a small lighting element. Furthermore, the LC display is also viewing angle independent due to the omission of the polarizers.

It can be provided that the LC display can be an LC display doped with color pigments. In particular, the LC display in this case can be a so-called dye-doped display, which is doped with color pigments which determine the color of the LC display in its non-operational state. Thus, for example, a black region can be visible, but so can a red or blue region or a region in any desired other color.

It is possible that the LC display can have a plurality of segments which can be controlled independently of one another. In this regard, the independently controllable segments of the LC display can differ from one another in terms of their size and/or their shape. Any pixelation of the LC display that can be designed as desired is advantageous with a passive LC display. The separately switchable pixels of the LC display can thereby be given any different shape and size, and thus actively define the desired design of a switchable matrix for the light function. For example, triangular, diamond-shaped, or square pixels, or pixels with any other shape can be specified and implemented, or special graphic elements such as letters, pictograms, or logos as well. In contrast to active LC displays with very small pixelation for high resolutions, passive LC displays, especially passive LC displays for automotive applications, generally have larger pixel areas.

It can be provided that the LC display plate, not formed by the light guide, is formed of glass or of an at least partially transparent plastic. In particular, the LC display plate, not formed by the light guide, and/or the light guide can be flexible. The shape of the lighting device or the shape of the illuminated surface of the lighting device can be adapted thereby to the shape of curved sections of the vehicle body.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic sectional view of an embodiment of a lighting device of the invention; and

FIG. 2 shows a front view the lighting device according to FIG. 1.

### DETAILED DESCRIPTION

The lighting device shown in the figures comprises at least one light source 1 formed as a light-emitting diode (LED), preferably a plurality of light sources 1 formed as light-emitting diodes, from which light 2 is emitted during operation of the lighting device. Light sources 1 are arranged on a common printed circuit board 3.

The lighting device furthermore comprises a flat light guide 4 with an input surface 5 and at least one output surface 6, wherein the lighting device is configured such that light 2 generated by the at least one light source 1 enters light guide 4 at least partially through input surface 5 and exits at least partially from the at least one output surface 6.

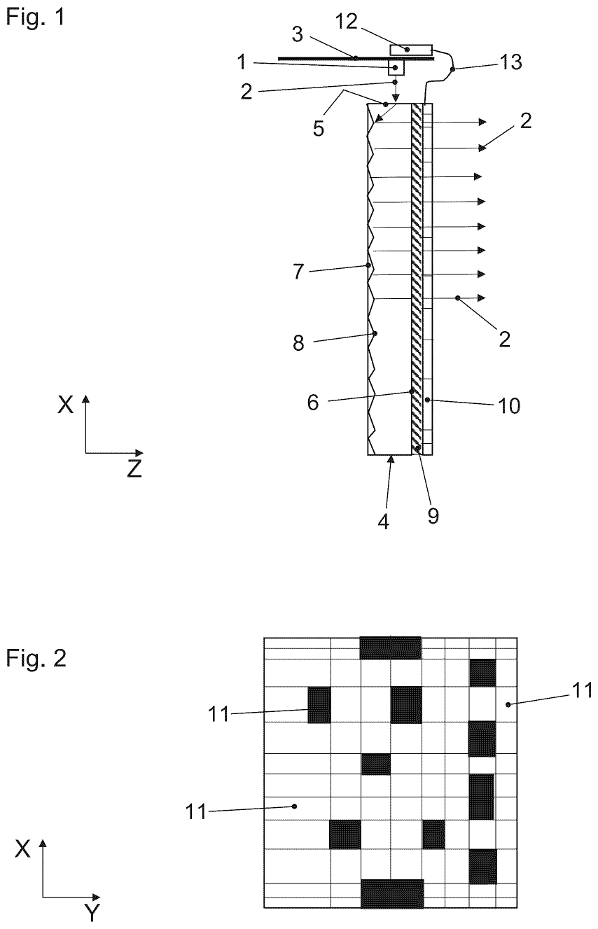

Input surface 5 of light guide 4 is formed as an end face, wherein the length and width of light guide 4 in a first direction X and a second direction Y perpendicular thereto is significantly greater than the thickness of the light guide in a third direction Z perpendicular to the first and second directions X, Y (see FIG. 1 and FIG. 2). In this regard, the at least one output surface 6 is arranged in an X-Y plane spanned by the first and second directions and input surface 5 is arranged in a Y-Z plane spanned by the second and third directions. In particular, the thickness of light guide 4 in the Z direction can be a few millimeters, for example, between 2 mm and 3 mm.

Light guide 4 has a structuring 8 on surface 7 opposite output surface 6, which is designed so that light 2 moving through light guide 4 is at least partially deflected by structuring 8 so that it emerges from light guide 4 through output surface 6 to the right in FIG. 1 or in the positive Z direction.

Surface 7 opposite output surface 6 can have a reflective layer that can reflect light 2 incident on surface 7 in a targeted manner in the direction of output surface 5. Alternatively, the lighting device can have a reflector, which is arranged outside light guide 4, wherein the lighting device is configured such that light 2 emerges from surface 7 opposite output surface 6 in the negative Z direction, is reflected again by the reflector in the direction of light guide 4, again enters light guide 4 through the surface 7 opposite output surface 6, and exits from light guide 4 through output surface 6 to the right in FIG. 1 or in the positive Z direction.

The lighting device furthermore comprises an LC display. The LC display has a liquid crystal layer 9 adjoining output surface 6 of light guide 4 in the positive Z direction. Furthermore, the LC display has an at least partially transparent plate 10, which is arranged on the side, facing away from light guide 4, of liquid crystal layer 9. In contrast to the state of the art, in which liquid crystal layer 9 is arranged between two transparent plates, in the illustrated embodiment liquid crystal layer 9 is arranged between light guide 4 and the at least partially transparent plate 10.

The LC display furthermore has a plurality of segments 11 which can be controlled independently of one another. In this case, the independently controllable segments 11 of the LC display can differ from one another in terms of their size and/or their shape. FIG. 2 shows the plurality of segments 11, some of which have a different size and shape.

For clarification, some of the segments 11 are in a state in which light 2 emerging from the at least one output surface 6 of light guide 4 passes relatively unhindered through the area, forming the corresponding segment 11, of liquid crystal layer 9 of the LC display and subsequently through plate 10 of the LC display. Furthermore, other illustrated segments 11 are in a state in which light 2 emerging from the at least one output surface 6 of light guide 4 cannot pass through the area, forming the corresponding segment 11, of liquid crystal layer 9.

To control segments 11, the lighting device comprises a schematically indicated control device 12, which is connected via a control line 13 to liquid crystal layer 9 and/or plate 10 delimiting liquid crystal layer 9 in such a way that it can switch in a suitable manner the areas, forming the individual segments, of liquid crystal layer 9 from a transmissive to a non-transmissive state and from a non-transmissive to a transmissive state.

In the illustrated exemplary embodiment, control device 12 is arranged together with light sources 1 on circuit board 3. However, it is entirely possible for control device 12 to be arranged separately.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A lighting device for a vehicle, the lighting device comprising:
at least one light source;
a flat light guide with an input surface and at least one output surface, the lighting device being configured such that the light generated by the at least one light source enters the light guide at least partially through the input surface and exits at least partially from the at least one output surface;
an LC display having two opposing, at least partially transparent plates and a liquid crystal layer arranged between these plates;
wherein one of the at least partially transparent plates of the LC display is formed by the flat light guide,
wherein the lighting device is configured such that the light emerging from the at least one output surface of the light guide passes at least partially through the liquid crystal layer of the LC display and subsequently through the LC display plate not formed by the light guide.

2. The lighting device according to claim 1, wherein the lighting device is configured such that the LC display is controlled in order to selectively allow parts of the light emerging from the at least one output surface of the light guide to pass through the LC display and not to allow other parts of the light emerging from the at least one output surface of the light guide to pass through the LC display.

3. The lighting device according to claim 1, wherein the input surface of the light guide is formed as an end face, or wherein the length and width of the light guide in a first direction and a second direction perpendicular thereto is significantly greater than the thickness of the light guide in a third direction perpendicular to the first and second directions, wherein the at least one output surface is arranged in a plane spanned by the first and second directions and the input surface is arranged in a plane spanned by the second and third directions.

4. The lighting device according to claim 1, wherein the light guide has a structuring, and wherein the lighting device is configured such that light moving through the light guide is at least partially deflected by the structuring so that it emerges from the light guide through the output surface.

5. The lighting device according to claim 4, wherein the structuring is arranged on a surface opposite the output surface adjacent to the liquid crystal layer.

6. The lighting device according to claim 1, wherein the lighting device has a reflective layer which is arranged on the surface opposite the output surface.

7. The lighting device according to claim 1, wherein the lighting device has a reflector disposed outside the light guide, wherein the lighting device is configured such that light emerges from the surface opposite the output surface, is reflected again by the reflector in the direction towards the light guide, again enters the light guide through the surface opposite the output surface, and emerges from the light guide through the output surface so that it passes through the liquid crystal layer of the LC display and subsequently through the LC display plate not formed by the light guide.

8. The lighting device according to claim 1, wherein the at least one light source is formed as a light-emitting diode, and wherein multiple light-emitting diodes are provided.

9. The lighting device according to claim 1, wherein the LC display is a passive LC display.

10. The lighting device according to claim 1, wherein the LC display is a guest-host display or a SmartGlass display.

11. The lighting device according to claim 1, wherein the LC display is an LC display doped with color pigments.

12. The lighting device according to claim 1, wherein the LC display has a plurality of segments which are controlled independently of one another.

13. The lighting device according to claim 12, wherein the independently controllable segments of the LC display differ from one another in terms of their size and/or their shape.

14. The lighting device according to claim 1, wherein the LC display plate, not formed by the light guide, is formed of glass or of an at least partially transparent plastic.

15. The lighting device according to claim 1, wherein the LC display plate, not formed by the light guide, and/or the light guide are flexible.
